(19) United States
(12) Patent Application Publication
(10) Pub. No.: US 2010/0246694 A1
(43) Pub. Date: Sep. 30, 2010

(54) Integrated reception system

(75) Inventors: Kohichi Tsutsui, Kobe-shi (JP); Kenji Kawai, Kobe-shi (JP); Eri Miyoshi, Kobe-shi (JP); Susumu Hasegawa, Kobe-shi (JP); Hirotaka Nakahara, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-Shi (JP)

(21) Appl. No.: 12/659,902

(22) Filed: Mar. 24, 2010

(30) Foreign Application Priority Data
Mar. 31, 2009 (JP) 2009-088464
Dec. 21, 2009 (JP) 2009-289804

(51) Int. Cl. H04L 27/00; H04B 3/00

(52) U.S. Cl. 375/257

(57) ABSTRACT

An integrated reception system includes an integrated antenna device and an integrated-signal processing device. The integrated antenna device fed with power from the integrated-signal processing device converts a high frequency signal received by an antenna for receiving a plurality of signals of different signal systems into a digital signal, demodulates the converted digital signal, multiplexes digital demodulated signals which are demodulated, modulates the high frequency signal based on the multiplexed demodulated signal, attenuates the modulated high frequency signal by a predetermined amount of attenuation, and outputs the attenuated signal. The integrated-signal processing device demodulates the high frequency signal, separates the demodulated signal into demodulated signals each digitized for each of the signal systems, and outputs the separated demodulated signal.

### CROSS-REFERENCE TO RELATED APPLICATIONS

This application is based upon and claims the benefit of priority from Japanese Patent Application No. 2009-088464, filed Mar. 31, 2009; and Japanese Patent Application No. 2009-289804, filed Dec. 21, 2009, the entire contents of which are incorporated herein by reference.

### BACKGROUND OF THE INVENTION

1. Field of the Invention

The present invention relates to an integrated reception system.

2. Description of the Related Art

Conventionally, there is known an integrated reception system in which a housing as an integrated antenna device integrated with an antenna digitizes and multiplexes signals of a plurality of systems received from a plurality of media such as AM, FM, and digital TV and transmits the signals, and a housing as a demodulator demodulates the signals transmitted therefrom.

For example, when the integrated reception system is installed in a vehicle, the demodulated signal is output, as a video signal and an audio signal, to an output device such as an in-vehicle monitor (e.g., a liquid crystal display and a touch panel) and an in-vehicle speaker.

Moreover, the housing as the integrated antenna device is disposed near an antenna, and the housing as the demodulator is disposed in an in-vehicle unit or the like installed in the vehicle. Both the integrated antenna device and the demodulator use power fed from a battery-dependent power feed unit, and are connected to each other with a cable or the like. Technologies for various integrated reception systems configured in the above manner are disclosed in Japanese Patent Application Laid-open No. 2008-294825 and International Publication Pamphlet No. WO 2007/058341.

However, the conventional technologies disclosed in Japanese Patent Application Laid-open No. 2008-294825 and International Publication Pamphlet No. WO 2007/058341 have some problem that processing load is applied to the integrated antenna device. More specifically, the integrated antenna device converts the received high frequency signal into a digital signal and also converts it into an intermediate frequency signal, multiplexes and modulates converted digital signals, and sends the signals to a cable.

Incidentally, the high frequency signal and the intermediate frequency signal have generally a large amount of data, and, thus, require a high transmission rate in order to transmit the large amount of data. Therefore, if the high transmission rate cannot be maintained, it can be considered that the demodulator cannot perform a demodulation process in a subsequent stage. Moreover, the maintenance of the high transmission rate in order to transmit the large amount of data results in the need of a component that performs signal processing with high performance.

### SUMMARY OF THE INVENTION

It is an object of the present invention to at least partially solve the problems in the conventional technology.

According to one aspect of the present invention, an integrated reception system includes: an integrated antenna device that includes a demodulation processor that demodulates a digital signal in a subsequent stage of a received-signal processor for converting a high frequency signal received by an antenna into the digital signal and in a previous stage of a multiplexing processor for multiplexing digital signals, a first digital modulation processor that modulates the high frequency signal based on a modulated signal multiplexed by the multiplexing processor, and a first communication processor that outputs the high frequency signal modulated by the first digital modulation processor, the integrated antenna device being disposed near the antenna; an integrated-signal processing device that includes a multiplex demodulator that demodulates the high frequency signal output from the integrated antenna device, and a power feed unit that feeds power to the integrated antenna device; and a transmission line, being a plurality of coaxial cables, that connects between the integrated antenna device and the integrated-signal processing device, and at both ends of which a connector is provided.

Further, according to another aspect of the present invention, an integrated reception system includes: an integrated antenna device that includes a received-signal processor that converts a high frequency signal received by an antenna into a digital signal, a demodulation processor that demodulates the digital signal, a multiplexing processor that multiplexes digital signals, a first digital modulation processor that modulates the high frequency signal based on the digital signals multiplexed by the multiplexing processor, and a first communication processor that outputs the high frequency signal modulated by the first digital modulation processor, the integrated antenna device being disposed near the antenna; an integrated-signal processing device that includes a multiplex demodulator that demodulates the high frequency signal output from the integrated antenna device, and a power feed unit that feeds power to the integrated antenna device; and a plurality of transmission lines each of which connects between the integrated antenna device and the integrated-signal processing device, and each of the transmission lines being provided with a connector at both ends thereof.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of a configuration example of an integrated reception system according to a first embodiment;

FIG. 2 is a schematic illustrating an example of how the integrated reception system according to the first embodiment is installed in a vehicle;

FIG. 3 is a diagram of a configuration example of an integrated reception system according to a second embodiment;

FIG. 4 is a diagram of a configuration example of an integrated reception system according to a third embodiment;

FIG. 5 is a schematic illustrating an example of how the integrated reception system according to the third embodiment is installed in a vehicle;

FIG. 6 is a diagram of a configuration example of an integrated reception system according to a fourth embodiment;

FIG. 7 is a diagram of a configuration example of an integrated reception system according to a fifth embodiment;

FIG. 8 is a schematic illustrating an example of how the integrated reception system according to the fifth embodiment is installed in a vehicle;

FIGS. 9A and 9B are schematics of configuration examples when the power is superimposed on a transmission line;

FIG. 10 is a diagram of a configuration example of an integrated reception system according to a seventh embodiment;

FIG. 11 is a schematic illustrating an example of an arrangement when the integrated reception system according to the seventh embodiment is installed in a vehicle;

FIG. 12 is a schematic illustrating an example of how the integrated reception system according to the seventh embodiment is installed in the vehicle;

FIG. 13 is a diagram of a configuration example of an integrated reception system according to an eighth embodiment;

FIG. 14 is a schematic illustrating an example of how the integrated reception system according to the eighth embodiment is installed in a vehicle; and

FIG. 15 is a diagram of a configuration example of an integrated reception system according to a ninth embodiment.

### DETAILED DESCRIPTION OF THE PREFERRED EMBODIMENTS

Exemplary embodiments of an integrated reception system disclosed in the present application will be explained below with reference to accompanying drawings. In the following, a case in which the integrated reception system is applied to a vehicle is explained. Furthermore, the present invention is not limited by the following embodiments.

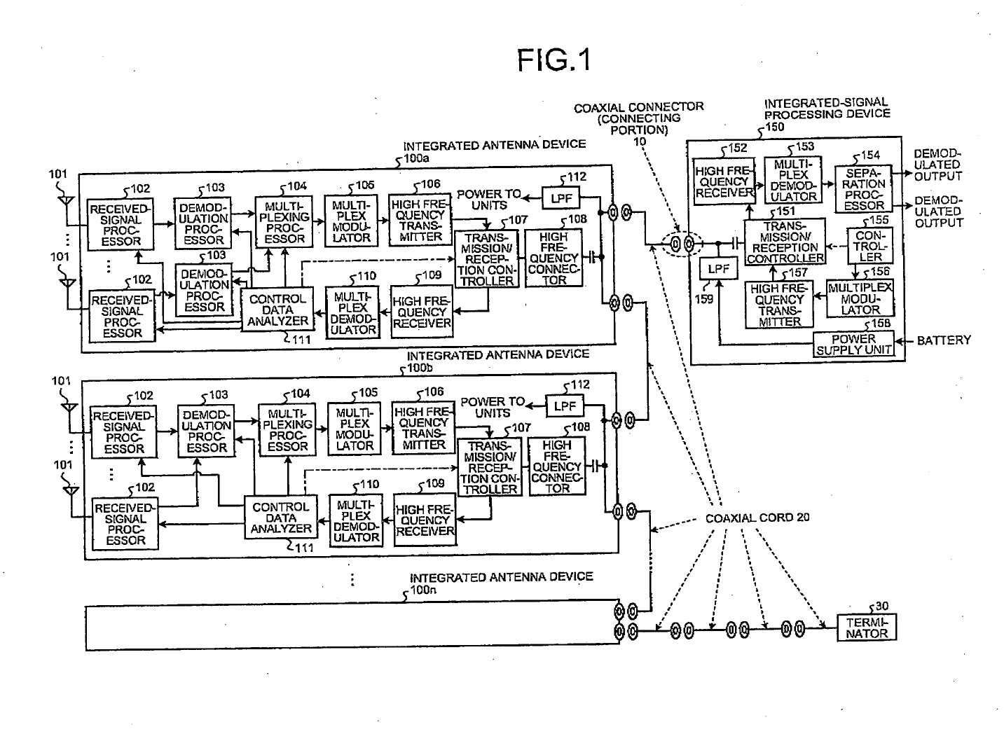

First, the configuration of an integrated reception system according to a first embodiment is explained with reference to FIG. 1. FIG. 1 is a diagram of a configuration example of the integrated reception system according to the first embodiment.

As shown in FIG. 1, the integrated reception system according to the first embodiment includes a plurality of coaxial connectors 10, a plurality of coaxial cords 20, a terminator 30, a plurality of integrated antenna devices 100a to 100n, and an integrated-signal processing device 150.

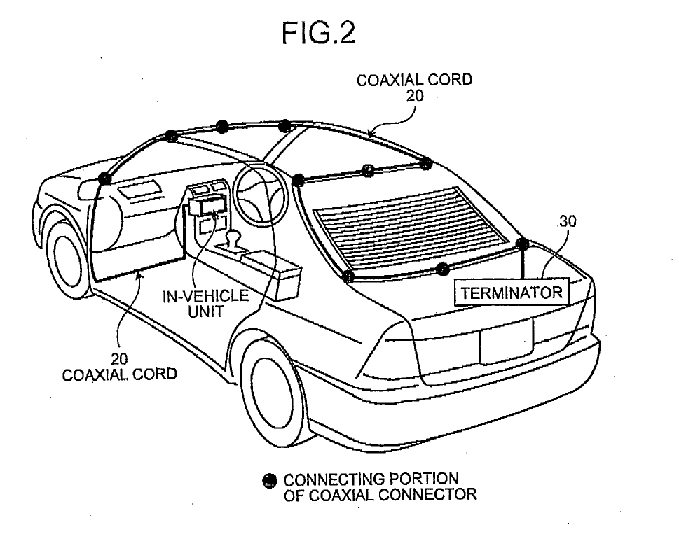

As shown in FIG. 2, for example, the coaxial connectors 10 are disposed near installation locations of the integrated antenna devices 100a to 100n, and the respective integrated antenna devices 100a to 100n are connected to each other with each coaxial cord 20. The coaxial cord 20 connected to the integrated antenna device in a final stage is connected to the terminator 30. Meanwhile, the integrated-signal processing device 150 is included in, for example, an in-vehicle unit installed in a vehicle and is connected to the integrated antenna device with the coaxial cord 20. FIG. 2 is a schematic illustrating an example of how the integrated reception system according to the first embodiment is installed in a vehicle.

In other words, the plurality of coaxial cords 20 are implemented in interior portions in the vehicle and a back side of a decorative panel or the like in vehicle interior, and the coaxial connectors 10 are respectively arranged near the installation locations of the plurality of integrated antenna devices 100a to 100n. It should be noted that the coaxial cord directly connects between the integrated antenna device 100n and the terminator 30 as shown in FIG. 1 if the housing is not disposed right under the antenna, so that a case where the housing is disposed right under the antenna or the housing is additionally installed can also be handled with the coaxial cord.

As shown in FIG. 1, the integrated antenna device 100a configured as above includes an antenna 101, a received-signal processor 102, a demodulation processor 103, a multiplexing processor 104, a multiplex modulator 105, a high frequency transmitter 106, a transmission/reception controller 107, a high frequency connector 108, a high frequency receiver 109, a multiplex demodulator 110, a control data analyzer 111, and a low pass filter (LPF) 112. In FIG. 1, in the integrated antenna devices 100a to 100n, the same numeral is assigned to components implementing the same process.

For example, the antenna 101 is disposed in predetermined plural locations in the vehicle, and receives a plurality of signals of different signal systems. The received-signal processor 102 converts a high frequency signal received by the antenna 101 into a digital signal. The received-signal processor 102 is disposed in the same number as that of the antenna 101 disposed in the plural locations.

Subsequently, the demodulation processor 103 demodulates the digital signal converted by the received-signal processor 102. The digital demodulated signal demodulated by the demodulation processor 103 has a less amount of information, as compared with a high frequency signal and an intermediate frequency signal input to the demodulation processor 103. Therefore, a data transmission rate of the digital demodulated signal can be lower as compared with the conventional technology in which signals subjected to received-signal processing are multiplexed.

Thereafter, the multiplexing processor 104 multiplexes digital demodulated signals demodulated by the demodulation processor 103. The multiplex modulator 105 modulates the high frequency signal based on the digital demodulated signals multiplexed by the multiplexing processor 104. Subsequently, the high frequency transmitter 106 amplifies the high frequency signal modulated by the multiplex modulator 105 to a predetermined level. It should be noted that the high frequency transmitter 106 includes an amplifier for amplifying the high frequency signal, and that the predetermined level amplified by the high frequency transmitter 106 is a level at which the signal can be sent to the coaxial cord 20 in the subsequent stage.

Thereafter, the transmission/reception controller 107 sends the high frequency signal amplified by the high frequency transmitter 106 to the integrated-signal processing device 150 through the high frequency connector 108. The high frequency connector 108 attenuates the high frequency signal input thereto by the transmission/reception controller 107 by a predetermined amount and outputs the attenuated signal.

Furthermore, the high frequency connector 108 attenuates the high frequency signal input thereto from the integrated-signal processing device 150 through the coaxial cord 20 by a predetermined amount and outputs the attenuated signal to the transmission/reception controller 107. The transmission/reception controller 107 receives the high frequency signal with the predetermined amount attenuated by the high frequency connector 108, and outputs the received high frequency signal to the high frequency receiver 109.

Subsequently, the high frequency receiver 109 amplifies the high frequency signal output by the transmission/reception controller 107 to a predetermined level. It should be noted that the high frequency receiver 109 includes an amplifier for amplifying the high frequency signal, and that the predetermined level amplified by the high frequency receiver 109 is a level at which a control signal being a baseband signal can be appropriately demodulated from the high frequency signal.

Thereafter, the multiplex demodulator 110 demodulates the control signal being the baseband signal from the high frequency signal amplified by the high frequency receiver 109. The control data analyzer 111 converts the control signal demodulated by the multiplex demodulator 110 into various data for each signal system of the control signal and outputs the data to each corresponding component. It should be noted that the corresponding component is the received-signal processor 102, the demodulation processor 103, or the multiplexing processor 104.

Furthermore, the high frequency connector 108 extracts only a DC voltage input from the integrated-signal processing device 150, and outputs the extracted DC voltage to the LPF 112. The DC voltage input to the high frequency connector 108 is input in such a manner that it is superimposed on the high frequency signal, and thus, only a direct-current component or the DC voltage is extracted. The LPF 112 uses the DC voltage extracted by the high frequency connector 108 for power feeding to the components of the integrated antenna device 100a.

Moreover, if the signal is to be output from the integrated antenna device 100a to an integrated antenna device such as the integrated antenna device 100b which is different from the own device, the high frequency connector 108 outputs the input high frequency signal to the integrated antenna device 100b connected thereto without being attenuated.

As shown in FIG. 1, the integrated-signal processing device 150 includes a transmission/reception controller 151, a high frequency receiver 152, a multiplex demodulator 153, a separation processor 154, a controller 155, a multiplex modulator 156, a high frequency transmitter 157, a power supply unit 158 and an LPF 159.

For example, the transmission/reception controller 151 receives the high frequency signal from the integrated antenna device 100a and outputs the high frequency signal to the high frequency receiver 152. The high frequency receiver 152 amplifies the high frequency signal output by the transmission/reception controller 151 to a predetermined level. It should be noted that the high frequency receiver 152 includes an amplifier for amplifying the high frequency signal, and that the predetermined level amplified by the high frequency receiver 152 is a level at which the control signal being the baseband signal can be appropriately demodulated from the high frequency signal in the multiplex demodulator 153 provided on the subsequent stage.

Subsequently, the multiplex demodulator 153 demodulates the control signal being the baseband signal from the high frequency signal amplified by the high frequency receiver 152. Thereafter, the separation processor 154 separates the demodulated signal demodulated by the multiplex demodulator 153 into demodulated signals each digitized for each signal system.

The controller 155 generates control signals for the integrated antenna devices 100a to 100n or the like. The control signal generated by the controller 155 is one that is converted to a control signal in which various data such as a reception frequency, a reception bandwidth, down sampling parameters, an orthogonal transformation frequency, and a transmission format are integrated. It should be noted that the various data are set by a user using a predetermined input device included in an in-vehicle unit installed in a vehicle. The multiplex modulator 156 modulates the high frequency signal based on the control signal generated by the controller 155.

Subsequently, the high frequency transmitter 157 amplifies the high frequency signal modulated by the multiplex modulator 156 to a predetermined level. It should be noted that the high frequency transmitter 157 includes an amplifier for amplifying the high frequency signal, and that the predetermined level amplified by the high frequency transmitter 157 is a level at which the amplified high frequency signal can be sent to the coaxial cord 20 provided on the subsequent stage. Thereafter, the transmission/reception controller 151 sends the high frequency signal amplified by the high frequency transmitter 157 to the integrated antenna devices 100a to 100n.

The power supply unit 158 decreases or increases voltage input from a battery or the like provided in the vehicle, and sends the voltage to the integrated antenna devices 100a to 100n. More specifically, the voltage sent by the integrated-signal processing device 150 is superimposed on the high frequency signal sent from the integrated-signal processing device 150 by passing through the LPF 159. In other words, the voltage output by the power supply unit 158 is superimposed on the high frequency signal and is sent to the integrated antenna devices 100a to 100n through the coaxial cord 20, and thus, there is no need to provide any cord for power feeding to the integrated antenna devices.

As explained above, in the integrated reception system, the integrated antenna devices 100a to 100n convert the high frequency signals received by the antennas into digital signals, demodulate the converted digital signals, and multiplex the digital demodulated signals which are demodulated. Therefore, as compared with the conventional technology for implementing the demodulation process in the device (e.g., demodulator) included in the in-vehicle unit or the like, the amount of information can be reduced and the processing load in the integrated antenna device can be reduced.

Moreover, in the integrated reception system, the integrated antenna devices 100a to 100n can reduce the amount of information. Therefore, the data transmission rate for the signals does not need to be high, which allows suppression of the cost as compared with the conventional technology requiring a high-performance component that processes a large amount of information or that supports the high data transmission rate.

Furthermore, in the integrated reception system, the integrated antenna device 100a and the integrated-signal processing device 150 are configured to attenuate an input/output of various signals by a predetermined amount of attenuation and to superimpose the power fed to the integrated antenna devices 100a to 100n on the high frequency signal respectively. Therefore, it is possible to achieve saving of the space required for installation of the integrated reception system in the vehicle without connecting between the integrated antenna devices 100a to 100n and the integrated-signal processing device 150 using discrete coaxial cords.

Incidentally, the first embodiment has explained the integrated reception system that includes the integrated antenna devices 100a to 100n, however, the integrated antenna device can also be disposed in one location.

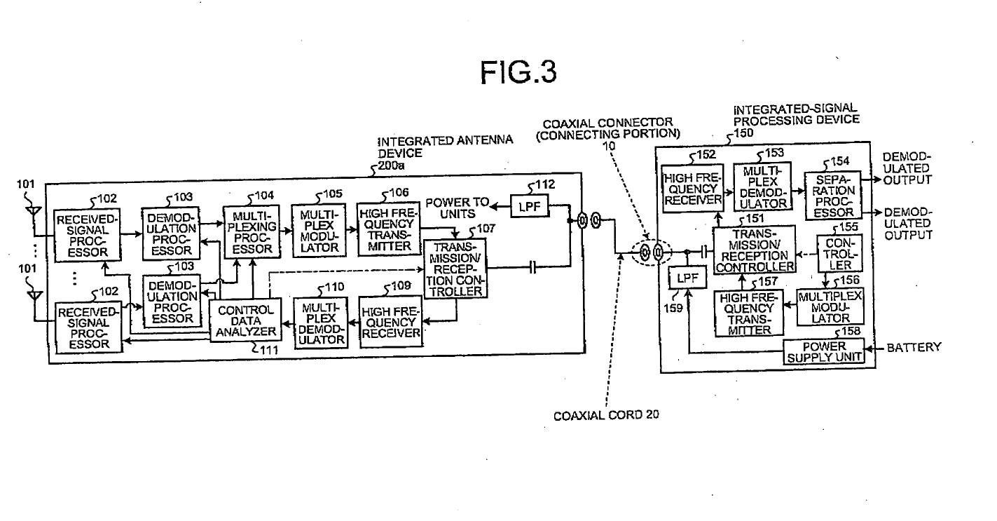

Therefore, a second embodiment as follows will explain the integrated reception system in which the integrated antenna device is disposed in one location with reference to FIG. 3.

The configuration of the integrated reception system according to the second embodiment is explained with reference to FIG. 3. FIG. 3 is a diagram of a configuration example of the integrated reception system according to the second embodiment. In FIG. 3, the same numerals are assigned to the same components as these of the integrated reception system according to the first embodiment. In the following, explanation of the same processes as these of the integrated reception system according to the first embodiment is omitted.

As shown in FIG. 3, the integrated reception system according to the second embodiment includes two coaxial connectors 10 being connecting portions for connecting between an integrated antenna device 200a and the integrated-signal processing device 150, a line of the coaxial cord 20, the integrated antenna device 200a, and the integrated-signal processing device 150.

When the integrated reception system according to the second embodiment is to be installed in the vehicle, for example, the coaxial connector 10 and the coaxial cord 20 as shown in FIG. 2 are used. In other words, the line of the coaxial cord 20 is implemented in the interior in the vehicle and on the backside of the decorative panel or the like in the vehicle interior, and the coaxial connector 10 is disposed near a predetermined installation location of the integrated antenna device 200a. Because the integrated reception system according to the second embodiment includes a single unit of the integrated antenna device 200a and a single unit of the integrated-signal processing device 150, and thus, the terminator is not needed.

In the above configuration, as shown in FIG. 3, the integrated antenna device 200a includes the received-signal processor 102, the demodulation processor 103, the multiplexing processor 104, the multiplex modulator 105, the high frequency transmitter 106, the transmission/reception controller 107, the high frequency receiver 109, the multiplex demodulator 110, the control data analyzer 111, and the LPF 112.

Here, a difference between the integrated antenna device 200a according to the second embodiment and the integrated antenna device 100a according to the first embodiment will be explained. As explained above, the integrated reception system according to the second embodiment includes the single unit of the integrated antenna device 200a and the single unit of the integrated-signal processing device 150, and thus, there is no need to relay various data and various signals received from the integrated-signal processing device 150, and also no need to relay various data and various signals received from an integrated antenna device different from the own integrated antenna device.

Namely, the integrated antenna device 200a does not require the high frequency connectors 108 included in the integrated antenna devices 100a to 100n. In other words, if the demodulation process is performed in the previous stage of the multiplexing process, reduction of the amount of information is expected. Therefore, the integrated reception system does not require provision of the plurality of integrated antenna devices.

As explained above, the integrated reception system causes the integrated antenna device 200a to implement the demodulation process in the previous stage of the multiplexing process, and thus enables reduction of the amount of information processed by the integrated antenna device 200a and enables reduction of the components required for arrangement of the plurality of integrated antenna devices. That is, the integrated reception system can further suppress the cost as compared with the case where the plurality of integrated antenna devices are installed in the vehicle.

Incidentally, the second embodiment has explained the integrated reception system in which the integrated antenna device is disposed in one location. However, it may be preferable that the antennas be arranged apart from each other in the systems of signals received by the antennas. As the case where it is preferable that the antennas be arranged apart from each other, there is considered a case of reception of a digital TV or the like in which a diversity structure with arrangement of a plurality of antennas helps improve a reception sensitivity.

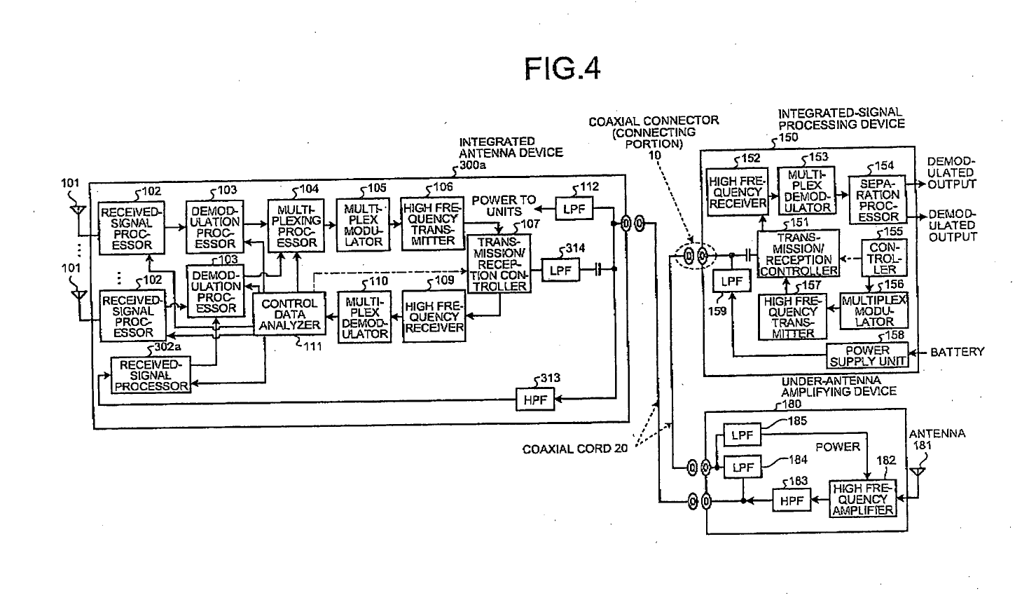

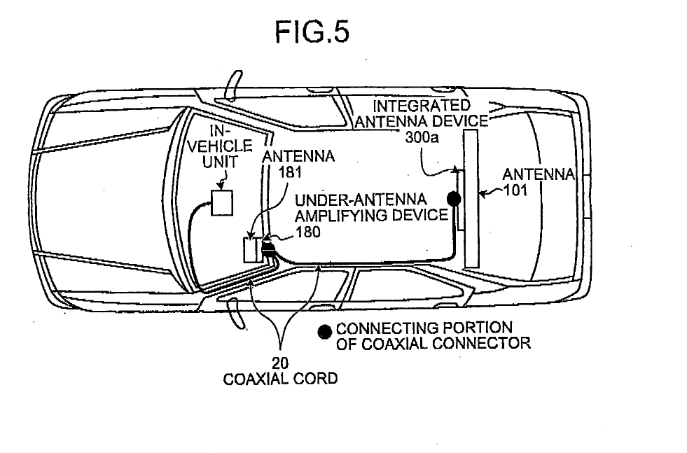

Therefore, a third embodiment as follows explains a case where antennas are arranged apart from each other with reference to FIG. 4 and FIG. 5.

The configuration of an integrated reception system according to the third embodiment will be explained with reference to FIG. 4. FIG. 4 is a diagram of a configuration example of the integrated reception system according to the third embodiment. In FIG. 4, the same numerals are assigned to the same components as these of the integrated reception system according to the first embodiment or the second embodiment. In the following, explanation of the same processes as these of the integrated reception system according to the first embodiment or the second embodiment is omitted.

As shown in FIG. 4, the integrated reception system according to the third embodiment includes four coaxial connectors 10 being connecting portions for connecting between an integrated antenna device 300a, an under-antenna amplifying device 180, and the integrated-signal processing device 150, and also includes two lines of the coaxial cords 20, the integrated antenna device 300a, the under-antenna amplifying device 180, and the integrated-signal processing device 150.

When the integrated reception system according to the third embodiment is to be installed in the vehicle, for example, as shown in FIG. 5, the integrated antenna device 300a is disposed in the rear portion of the vehicle, the under-antenna amplifying device 180 is disposed in the front portion of the vehicle, and the integrated-signal processing device 150 is disposed in such a manner that it is included in the in-vehicle unit or the like installed in the vehicle similarly to that of the first embodiment and the second embodiment.

The integrated reception system includes four coaxial connectors 10 and two coaxial cords 20. More specifically, the coaxial cord 20 connects between the integrated antenna device 300a and the under-antenna amplifying device 180 through the coaxial connectors 10, and the coaxial cord 20 connects between the under-antenna amplifying device 180 and the integrated-signal processing device 150 through the coaxial connectors 10. Moreover, the integrated reception system according to the third embodiment does not require the terminator similarly to the second embodiment. FIG. 5 is a schematic illustrating an example of how the integrated reception system according to the third embodiment is installed in a vehicle. In the following, there is explained a case where the signal received by the under-antenna amplifying device 180 is output, through the integrated antenna device 300a and again through the under-antenna amplifying device 180, to the integrated-signal processing device 150.

In the above configuration, the under-antenna amplifying device 180 includes an antenna 181, a high frequency amplifier 182, a hi pass filter (HPF) 183, an LPF 184, and an LPF 185.

For example, the antenna 181 is disposed in a predetermined location of the vehicle apart from the integrated antenna device 300a, and receives a high frequency signal of digital TV (e.g., frequency of 470 to 710 MHz) or the like. The high frequency amplifier 182 amplifies a high frequency signal received by the antenna 181 to a predetermined, level, and sends the signal to the integrated antenna device 300a through the HPF 183. The predetermined level of the high frequency signal amplified by the high frequency amplifier 182 is a level at which it can be sent to the coaxial cord 20.

The LPF 184 relays various data or signals received from the integrated-signal processing device 150 and the integrated antenna device 300a or the like, and sends them from the integrated-signal processing device 150 to the integrated antenna device 300a or from the integrated antenna device 300a to the integrated-signal processing device 150. The various data or the signals (e.g., signal in which demodulated signals are multiplexed) to be relayed are implemented at a low frequency of, for example, 4 to 30 MHz. The LPF 185 uses the DC voltage received from the integrated-signal processing device 150 for power feeding to the components such as the high frequency amplifier 182.

The integrated antenna device 300a includes the received-signal processor 102, a received-signal processor 302a, the demodulation processor 103, the multiplexing processor 104, the multiplex modulator 105, the high frequency transmitter 106, the transmission/reception controller 107, the high frequency receiver 109, the multiplex demodulator 110, the control data analyzer 111, the LPF 112, an HPF 313, and an LPF 314.

For example, the HPF 313 receives the high frequency signal sent by the high frequency amplifier 182 included in the under-antenna amplifying device 180, and outputs the high frequency signal to the received-signal processor 302a. The received-signal processor 302a converts the high frequency signal output by the HPF 313 into a digital signal and outputs the digital signal to the demodulation processor 103.

Subsequently, the demodulation processor 103 demodulates the digital signal converted by the received-signal processor 302a. Thereafter, the multiplexing processor 104 multiplexes digital demodulated signals demodulated by the demodulation processor 103.

Thereafter, the transmission/reception controller 107 sends the high frequency signal amplified by the high frequency transmitter 106 to the integrated-signal processing device 150 through the LPF 314 and the under-antenna amplifying device 180. The process upon reception of the signal by the antenna 101 in the integrated antenna device 300a is the same as that of the first embodiment or the second embodiment. The power feeding in the integrated antenna device 300a is implemented by supplying the power from the integrated-signal processing device 150 in the same manner as that of the first embodiment or the second embodiment although through the under-antenna amplifying device 180.

The integrated-signal processing device 150 includes the transmission/reception controller 151, the high frequency receiver 152, the multiplex demodulator 153, the separation processor 154, the controller 155, the multiplex modulator 156, the high frequency transmitter 157, the power supply unit 158, and the LPF 159.

For example, the transmission/reception controller 151 receives the high frequency signal input from the integrated antenna device 300a through the under-antenna amplifying device 180, and outputs the high frequency signal to the high frequency receiver 152. It should be noted that the process performed by the integrated-signal processing device 150 is the same as that of the first embodiment or the second embodiment, and thus explanation thereof is omitted.

As explained above, when the integrated reception system has the diversity structure in which antennas to be implemented are arranged separately from each other as far as possible, the under-antenna amplifying device 180 and the integrated antenna device 300a are separated from each other as far as possible, and the high frequency signal received by the under-antenna amplifying device 180 is input to the integrated antenna device 300a that can reduce the amount of information by executing the demodulation process in the previous stage of the multiplexing process. Then, the various processes capable of being executed by a signal with a low frequency are thereby performed on the input signal and the signal is sent to the integrated-signal processing device 150 through the under-antenna amplifying device 180. Therefore, the coaxial cords each connecting between the devices are not needed for wiring when the integrated reception system is installed in the vehicle.

More specifically, when the integrated reception system is installed in the vehicle, the exterior and the space of the vehicle due to installation of the integrated reception system therein are thought important, and thus, the present integrated reception system achieves the space saving by reducing the number of wirings and designing of the vehicle is made easy as compared with the integrated reception system having a large number of coaxial cords.

Incidentally, the second embodiment or the third embodiment has explained the case of the integrated reception system in which the integrated antenna device is disposed in one location. However, the integrated antenna device may not be disposed in one location depending on the specification of vehicles.

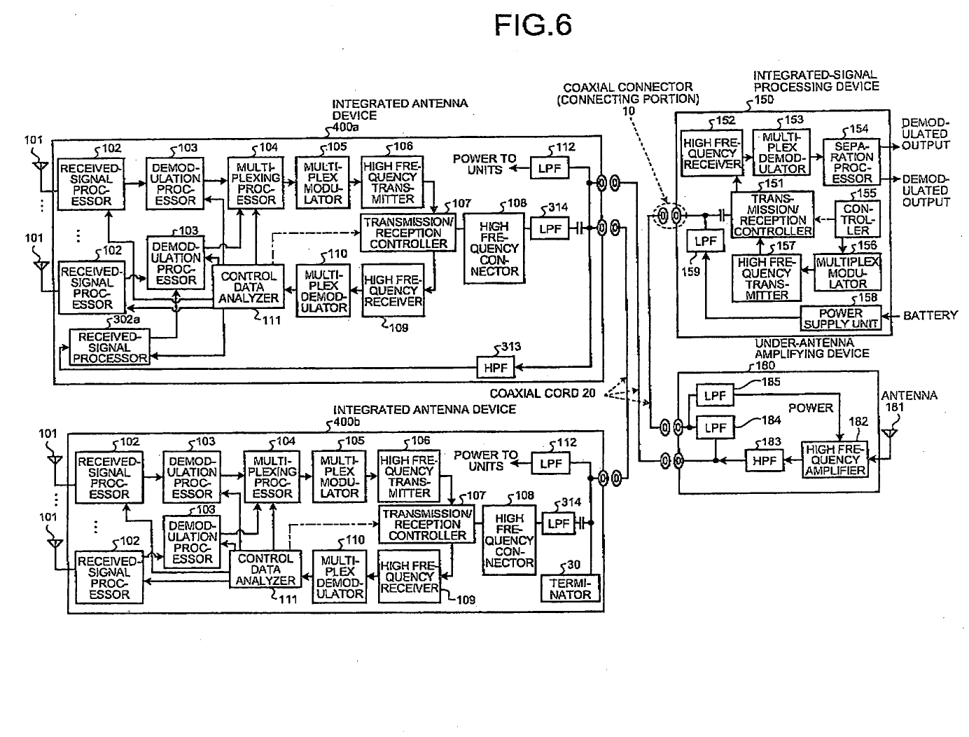

Therefore, a fourth embodiment as follows will explain an integrated reception system with reference to FIG. 6 in a case where power feed points of the antennas are largely separated into right and left sides due to the specification of an arrangement of antennas on a rear glass of the vehicle. In the following, similarly to the third embodiment, explanation is made based on assumption that the integrated reception system includes the under-antenna amplifying device 180 or has the diversity structure.

The configuration of the integrated reception system according to the fourth embodiment will be explained with reference to FIG. 6. FIG. 6 is a diagram of a configuration example of the integrated reception system according to the fourth embodiment. In FIG. 6, the same numerals are assigned to the same components as these of the integrated reception system according to the first to the third embodiments. In the following, for the same processes as these performed by the integrated reception systems according to the first to the third embodiments, explanation thereof is omitted.

As shown in FIG. 6, the integrated reception system according to the fourth embodiment includes the plurality of coaxial connectors 10, the plurality of coaxial cords 20, the terminator 30, an integrated antenna device 400a, an integrated antenna device 400b, the integrated-signal processing device 150, and the under-antenna amplifying device 180.

When the integrated reception system according to the fourth embodiment is to be installed in the vehicle, for example, the integrated antenna device 400b including the terminator 30 and the integrated antenna device 400a are connected to each other by the coaxial cord 20. The integrated antenna device 400a and the under-antenna amplifying device 180 are connected to each other by the coaxial cord 20. Furthermore, the under-antenna amplifying device 180 and the integrated-signal processing device 150 are connected to each other by the coaxial cord 20.

The antennas are separately disposed on, for example, a rear glass in the rear portion of the vehicle, or near the integrated antenna device 400b and the integrated antenna device 400a, and the antenna is disposed on a front glass in the front portion of the vehicle or near the under-antenna amplifying device 180 similarly to the third embodiment. It should be noted that the integrated-signal processing device 150 is disposed in such a manner that it is included in the in-vehicle unit or the like installed in the vehicle similarly to that of the first embodiment to the third embodiments.

In the above configuration, each of the integrated antenna device 400a and the integrated antenna device 400b includes the received-signal processor 102, the demodulation processor 103, the multiplexing processor 104, the multiplex modulator 105, the high frequency transmitter 106, the transmission/reception controller 107, the high frequency connector 108, the high frequency receiver 109, the multiplex demodulator 110, the control data analyzer 111, the LPF 112, and the LPF 314.

The integrated antenna device 400a further includes the received-signal processor 302a and the HPF 313 similarly to the third embodiment. Meanwhile, the integrated antenna device 400b further includes the terminator 30. It should be noted that the terminator 30 may be disposed outside the integrated antenna device 400b.

The integrated reception system according to the fourth embodiment includes a plurality of integrated antenna devices, and therefore, each of the integrated antenna device 400a and the integrated antenna device 400b includes the high frequency connector 108. Furthermore, because the integrated reception system according to the fourth embodiment includes the under-antenna amplifying device 180 for the purpose of the diversity structure or the like, each of the integrated antenna device 400a and the integrated antenna device 400b includes the LPF 314 similarly to the third embodiment, and the integrated antenna device 400a includes the HPF 313 and the received-signal processor 302a similarly to the third embodiment. It should be noted that the HPF 313 and the received-signal processor 302a may be included in the integrated antenna device 400b.

The integrated-signal processing device 150 includes the transmission/reception controller 151, the high frequency receiver 152, the multiplex demodulator 153, the separation processor 154, the controller 155, the multiplex modulator 156, the high frequency transmitter 157, the power supply unit 158, and the LPF 159. Meanwhile, the under-antenna amplifying device 180 includes the antenna 181, the high frequency amplifier 182, the HPF 183, the LPF 184, and the LPF 185.

For example, the high frequency signal received by the antenna 181 is processed by the integrated antenna device 400a as explained in the third embodiment, and is sent to the integrated-signal processing device 150 through the under-antenna amplifying device 180. Furthermore, for example, the high frequency signal received by the antenna 101 is processed by the integrated antenna device 400a or the integrated antenna device 400b as explained in the first embodiment, and is sent to the integrated-signal processing device 150 through the under-antenna amplifying device 180.

It should be noted that the power feeding to the integrated antenna device 400a, the integrated antenna device 400b, and to the under-antenna amplifying device 180, and the sending of the control signal from the integrated-signal processing device 150 to the integrated antenna device 400a or the integrated antenna device 400b are the same as these of the first to the third embodiments, and thus explanation thereof is omitted.

As explained above, when the integrated reception system has the diversity structure in which antennas to be implemented are arranged separately from each other as far as possible and are separated into right and left sides along the rear glass depending on the power feed points of the antennas in the vehicle, the integrated antenna device 400a and the integrated antenna device 400b are laterally disposed along the rear glass, and the under-antenna amplifying device 180 is disposed on the front glass. Therefore, the coaxial cords each connecting between the devices are not needed for wiring while supporting the diversity structure and the specification or the like of the vehicle.

Incidentally, the fourth embodiment has explained the case of the integrated reception system in which the power feed points of the antennas are separated into right and left-sides along the rear glass. However, a plurality of antennas connected to one demodulation system may also be laterally separated along the rear glass due to the specification of the diversity structure.

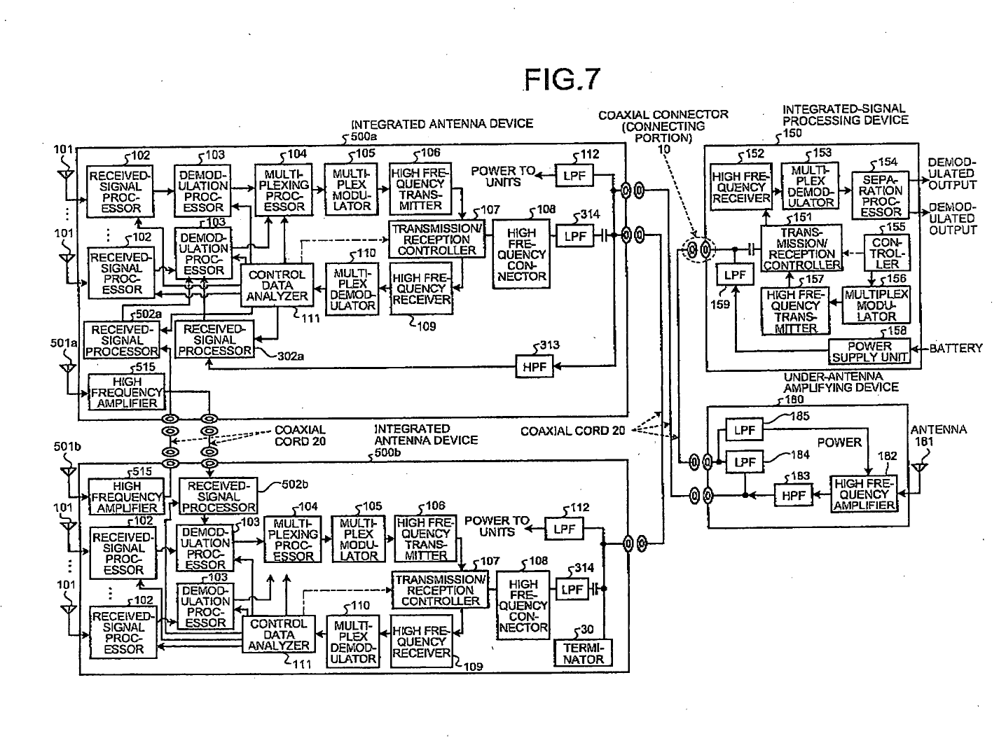

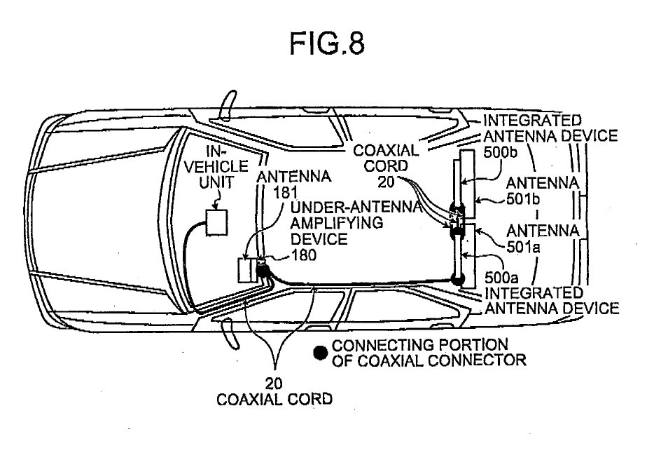

Therefore, a fifth embodiment as follows will explain an integrated reception system with reference to FIG. 7 and FIG. 8 in a case where a plurality of antennas connected to one demodulation system are largely separated into right and left sides along the rear glass due to the specification of the diversity structure.

The configuration of the integrated reception system according to the fifth embodiment will be explained with reference to FIG. 7. FIG. 7 is a diagram of a configuration example of the integrated reception system according to the fifth embodiment. In FIG. 7, the same numerals are assigned to the same components as these of the integrated reception system according to the first to the fourth embodiments. In the following, for the same processes as these performed by the integrated reception systems according to the first to the fourth embodiments, explanation thereof is omitted.

As shown in FIG. 7, the integrated reception system according to the fifth embodiment includes the plurality of coaxial connectors 10, the plurality of coaxial cords 20, the terminator 30, an integrated antenna device 500a, an integrated antenna device 500b, the integrated-signal processing device 150, and the under-antenna amplifying device 180.

When the integrated reception system according to the fifth embodiment is to be installed in the vehicle, for example, as shown in FIG. 8, the integrated antenna device 500a and the integrated antenna device 500b are disposed in the rear portion of the vehicle, the under-antenna amplifying device 180 is disposed in the front portion of the vehicle, and the integrated-signal processing device 150 is disposed in such a manner that it is included in the in-vehicle unit or the like installed in the vehicle similarly to the first to the fourth embodiments.

The integrated reception system includes the coaxial cord 20 connecting between the integrated antenna device 500a and the integrated antenna device 500b through the coaxial connectors 10. The integrated reception system also includes the coaxial cord 20 connecting between the integrated antenna device 500a and the under-antenna amplifying device 180 through the coaxial connectors 10. The integrated reception system also includes the coaxial cord 20 connecting between the under-antenna amplifying device 180 and the integrated-signal processing device 150 through the coaxial connectors 10. Furthermore, the integrated reception system includes two coaxial cords 20, separately from the above, connecting between the integrated antenna device 500a and the integrated antenna device 500b through the coaxial connectors 10. In other words, the integrated reception system includes five coaxial cords. FIG. 8 is a schematic illustrating an example of how the integrated reception system according to the fifth embodiment is installed in the vehicle.

In the above configuration, each of the integrated antenna device 500a and the integrated antenna device 500b includes the antenna 101, the received-signal processor 102 the demodulation processor 103, the multiplexing processor 104, the multiplex modulator 105, the high frequency transmitter 106, the transmission/reception controller 107, the high frequency connector 108, the high frequency receiver 109, the multiplex demodulator 110, the control data analyzer 111, the LPF 112, the LPF 314, and a high frequency amplifier 515.

The integrated antenna device 500a also includes the received-signal processor 302a and the HPF 313, and further includes an antenna 501a and a received-signal processor 502a. Meanwhile, the integrated antenna device 500b further includes an antenna 501b, a received-signal processor 502b, and the terminator 30. It should be noted that the terminator 30 may be disposed outside the integrated antenna device 500b.

These antenna 501a and antenna 501b are assigned with new numerals because they are related to processes performed by the high frequency amplifier 515 in the subsequent stage although they perform the same process as that of the antenna 101 included in each of the integrated antenna devices. In the following, there is explained a case where the high frequency signal received by the antenna 501b included in the integrated antenna device 500b is sent to the integrated-signal processing device 150 through the integrated antenna device 500a.

For example, the high frequency amplifier 515 amplifies the high frequency signal received by the antenna 501b to a predetermined level, and sends the signal to the received-signal processor 502a provided in the integrated antenna device 500a. The predetermined level of the high frequency signal amplified by the high frequency amplifier 515 is a level at which it can be sent to the coaxial cord 20 connecting between the high frequency amplifier 515 and the received-signal processor 502a.

The received-signal processor 502a converts the high frequency signal amplified by the high frequency amplifier 515 into a digital signal. Subsequently, the demodulation processor 103 demodulates the digital signal converted by the received-signal processor 502a. It should be noted that the process performed in the subsequent stage of the demodulation processor 103 is the same as that of the first to the fourth embodiments, and thus, explanation thereof is omitted. Furthermore, the case where the high frequency signal received by the integrated antenna device 500a is sent to the integrated antenna device 500b is also the same as the above process.

As for the connection between the integrated antenna device 500a and the integrated antenna device 500b, because there is a plurality of lines, it is preferable that the integrated antenna device 500a and the integrated antenna device 500b be arranged close to each other. As for the integrated-signal processing device 150 and the under-antenna amplifying device 180, the same processes as these of the first to the fourth embodiments are preformed.

As explained above, in the integrated reception system, even if a plurality of antennas connected to one demodulation system may be largely separated into right and left sides along the rear glass due to the specification of the diversity structure, the integrated antenna device arranged close to the antenna is connected thereto, and receives the high frequency signal from other integrated antenna device, and demodulates and outputs the received high frequency signal. Therefore, it is possible to achieve the space saving and cost saving while suppressing the wirings to a minimum.

The embodiments of the present invention have been explained so far, however, the present invention may be implemented in various different modes other than the embodiments. Therefore, different embodiments of the “system configuration” will be explained as follows.

Among the processes explained in the embodiments, the whole or a part of the processes explained as these automatically performed can be manually performed. In addition, the processing procedures, the control procedures, and the information (e.g., name such as “integrated antenna device”) including the specific names, the various data, and the parameters shown in the document and the figures can be changed unless otherwise specified.

Moreover, the components of the shown devices are functionally conceptual, and thus they are not necessarily physically configured as shown in the figures. More specifically, specific modes indicating the distribution and the integration of the devices are not limited to these as shown in the figures. The whole or the part thereof can be configured by functionally or physically distributing and integrating (e.g., an integration of the transmission/reception controller 107 and the high frequency connector 10B as a first communication processor) the whole or the part thereof in arbitrary units according to various loads and use patterns. Furthermore, the whole or an arbitrary part of the functions of the processes performed by the devices can be implemented by a CPU and a program analyzed and executed by the CPU, or can be implemented as hardware based on wired logic.

The first to the fifth embodiments have explained the examples in which the demodulation processor 103 is arranged in the subsequent stage of the received-signal processor 102 and in the previous stage of the multiplexing processor 104. However, if any other arrangement is appropriate, the arrangement is not limited thereto. In other words, for the arrangement of the demodulation processor 103, because the demodulation processor 103 is arranged in the integrated antenna devices in order to reduce the data amount, the location where the demodulation processor 103 is arranged is not limited thereto if the processing load in the integrated antenna devices can be reduced.

There has been explained so far the case where by arranging the demodulation process of the integrated reception system according to the present invention in the integrated antenna devices, the amount of information of the whole system is reduced and the processing load is reduced. Therefore, in such a case, the devices can be connected by a transmission path of a single system in a state of being like beads or in a daisy chain mode.

The embodiments have explained the case where the coaxial cord 20 is used as the transmission line. However, the transmission line used for such connection is not limited to the coaxial cord 20, and thus any other transmission line such as a twist pair cable can also be used.

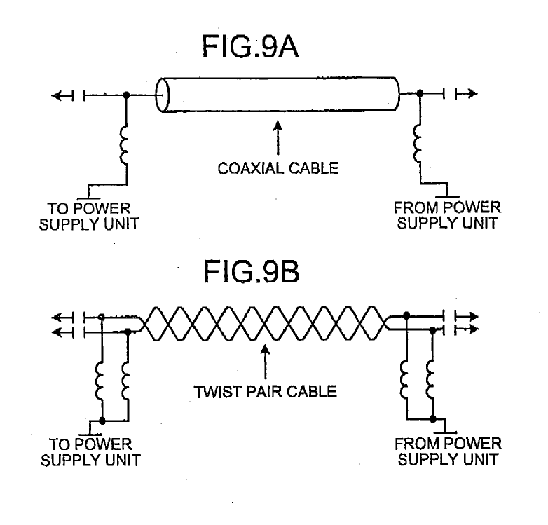

Therefore, a case where the twist pair cable is used as the transmission line will be explained below. First, the configuration in which the power is superimposed on the twist pair cable is explained with reference to FIG. 9B. FIGS. 9A and 9B are schematics of configuration examples when the power is superimposed on the transmission line. Specifically, FIG. 9A represents a case of a coaxial cable, while FIG. 9B represents a case of a twist pair cable.

As shown in FIG. 9A, in the case of the coaxial cable, the power superimposition can be performed by applying a voltage from the power supply unit to an inner conductor thereof. Likewise, in the case of the twist pair cable as shown in FIG. 9B, the power superimposition can be performed by sending a voltage from the power supply unit to respective cable cores.

Incidentally, the configuration of connection between the devices of the integrated reception system according to the present invention is not limited to the connection in the daisy chain mode. For example, a plurality of connection interfaces may be provided in the integrated-signal processing device 150 and transmission paths of a plurality of systems each beginning at the integrated-signal processing device 150 may be provided. The diversity structure may be implemented by the transmission paths of the plurality of systems.

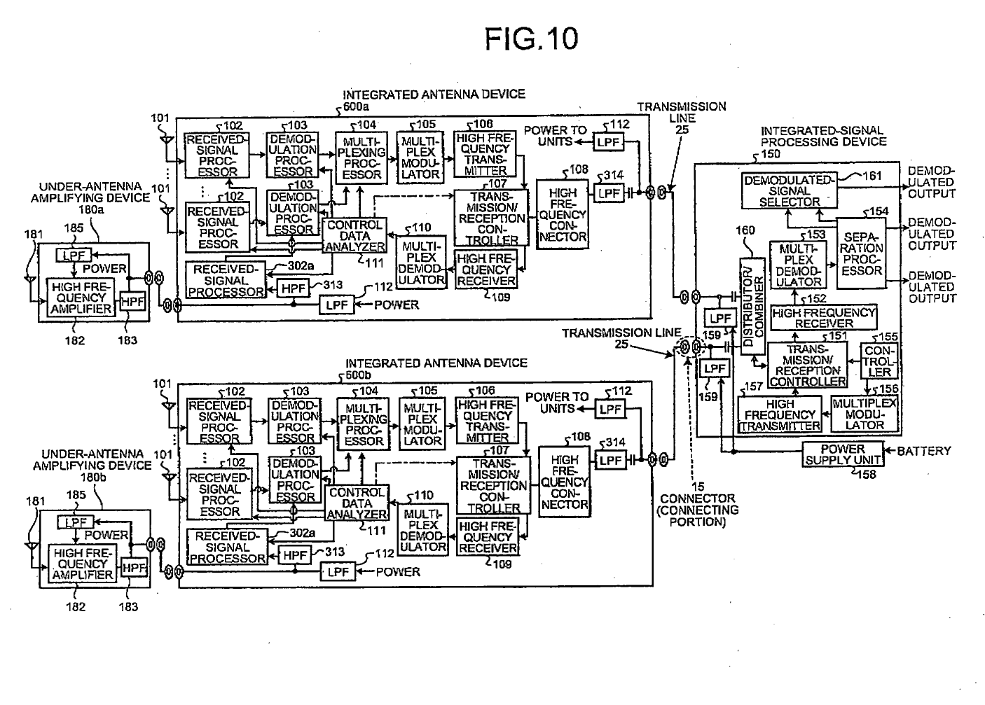

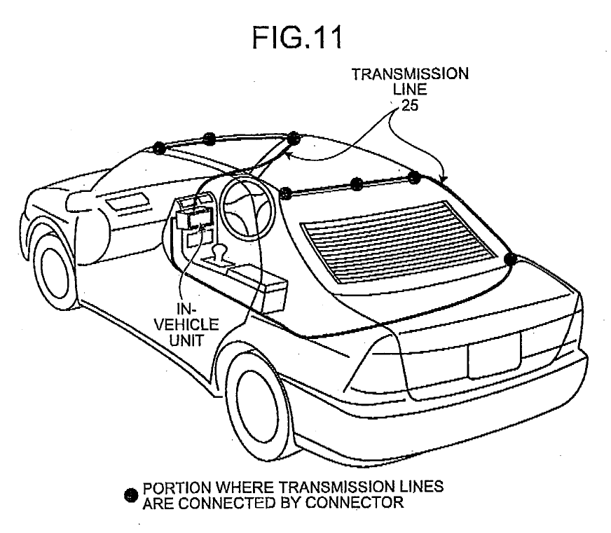

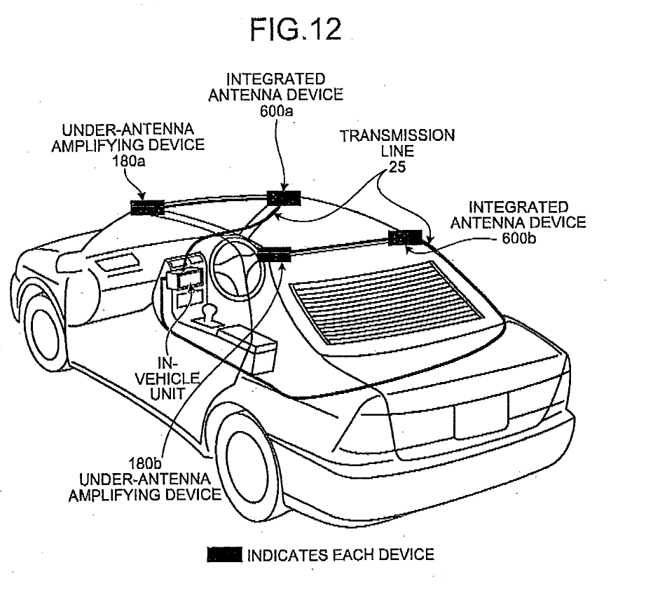

Therefore, in a seventh embodiment as follows, a case in which the integrated-signal processing device 150 includes a plurality of connection interfaces will be explained with reference to FIG. 10, FIG. 11, and FIG. 12. FIG. 10 is a diagram of a configuration example of an integrated reception system according to a seventh embodiment, FIG. 11 is a schematic illustrating an example of arrangement when the integrated reception system according to the seventh embodiment is installed in a vehicle, and FIG. 12 is a schematic illustrating an example of how the integrated reception system according to the seventh embodiment is installed in the vehicle.

In the following, a case where the integrated-signal processing device 150 includes two connection interfaces will be explained, however, three or more connection interfaces may be provided. In addition, an antenna selection method is used as the diversity structure.

First, the configuration of the integrated reception system according to the seventh embodiment will be explained with reference to FIG. 10. In FIG. 10, the same numerals are assigned to the same components as these in the integrated reception systems according to the embodiments. In the following, different points from the embodiments are mainly explained, and thus, explanation of the same portions is omitted or the explanation may be made briefly.

As shown in FIG. 10, the integrated reception system according to the seventh embodiment includes the integrated-signal processing device 150 that includes two connection interfaces, an integrated antenna device 600a, an integrated antenna device 600b, an under-antenna amplifying device 180a, an under-antenna amplifying device 180b, a plurality of connectors 15, and a plurality of transmission lines 25.

The integrated antenna device 600a and the under-antenna amplifying device 180a are connected to each other by the transmission line 25 and the connectors 15, to be formed, for example, as a front-side antenna device arranged on the front side of the vehicle. Likewise, the integrated antenna device 600b and the under-antenna amplifying device 180b are formed as a rear-side antenna device.

The integrated-signal processing device 150 and the integrated antenna device 600a are connected to each other through one of the connection interfaces of the integrated-signal processing device 150, and the integrated-signal processing device 150 and the integrated antenna device 600b are connected to each other through the other connection interface, these connections being implemented by the transmission line 25 and the connectors 15.

Here, an arrangement of the transmission lines when the physical connection is implemented and an arrangement of the devices will be explained with reference to FIG. 11 and FIG. 12.

As shown in FIG. 11, if the transmission paths of two systems beginning at the integrated-signal processing device 150 included in an in-vehicle unit or the like are structured, as the transmission path on the front side of the vehicle, for example, the transmission line 25 can be arranged by using only the front-side structure of the vehicle such as a front glass and a front pillar.

As shown in this figure, as the rear-side transmission path, similarly to the above, an arrangement can be implemented independently from the arrangement of the front-side transmission path in such a manner that the transmission line 25 is caused to pass to the rear side of the vehicle from a center console through a floor.

More specifically, as compared with the connection in the daisy chain mode, a short transmission line 25 can be used, and the degree of freedom of the arrangement can be also enhanced. Details of this point will be explained later.

As shown in FIG. 12, when the transmission lines 25 shown in FIG. 11 are arranged, the devices of the integrated reception system according to the seventh embodiment can be arranged in such a manner that as the front-side antenna device, for example, the integrated antenna device 600a and the under-antenna amplifying device 180a can be arranged in the front portion of the vehicle.

Likewise, the integrated antenna device 600b and the under-antenna amplifying device 180b can be arranged as the rear-side antenna device in the rear portion of the vehicle. By arranging the devices separately, this allows the diversity structure.

Furthermore, because the transmission paths of the two systems each beginning at the integrated-signal processing device 150 included in the in-vehicle unit or the like are structured, even if the transmission path of one of the systems is disconnected, the operation of the integrated reception system according to the present invention can be continued by using the other system. Therefore, the availability of the system itself can be improved.

Referring back to FIG. 10, the integrated-signal processing device 150 according to the seventh embodiment will be explained below. The integrated-signal processing device 150 includes the transmission/reception controller 151, the high frequency receiver 152, the multiplex demodulator 153, the separation processor 154, the controller 155, the multiplex modulator 156, the high frequency transmitter 157, the power supply unit 158, two LPFs 159 corresponding to the two connection interfaces, a distributor/combiner 160, and a demodulated-signal selector 161. FIG. 10 represents the example in which the power supply unit 158 is arranged outside the integrated-signal processing device 150, however, the power supply unit 158 may be arranged inside the device.

Here, the distributor/combiner 160 is a processor that receives and combines high frequency signals received through the two connection interfaces from the integrated antenna device 600a or the like, and outputs the combined signal to the transmission/reception controller 151.

The distributor/combiner 160 is also a processor that distributes the high frequency signal received from the transmission/reception controller 151 according to the two connection interfaces, and sends out the distributed high frequency signal to the integrated antenna device 600a or the like.

The distributor/combiner 160 is also a processor that performs a process for preventing undesired reflections of the high frequency signal when one of the two connection interfaces is not connected yet. More specifically, this case allows the integrated-signal processing device 150 not to require the terminator 30.

The demodulated-signal selector 161 is a processor that selects and outputs a demodulated signal separated for each signal system (e.g., separation between a front-side demodulated signal and a rear-side demodulated signal) by the separation processor 154.

The other processors of the integrated-signal processing device 150 are the same as these of the embodiments, and thus explanation thereof is omitted here. The integrated antenna device 600a, the integrated antenna device 600b, the under-antenna amplifying device 180a, and the under-antenna amplifying device 180b are also the same as these of the fourth embodiment, and thus, explanation thereof is omitted here.

As explained above, the integrated reception system according to the seventh embodiment is configured so that the integrated-signal processing device 150 includes a plurality of connection interfaces, and thus, the degree of freedom in the arrangement of the transmission lines 25 can be improved.

More specifically, for example, there is a case where an arrangement may disrupt the operation of an air bag due to the connection in the daisy chain mode in which the transmission lines 25 can be long. In this case, however, the arrangement can be performed in consideration of a safety aspect.

Furthermore, because the integrated reception system is configured with transmission paths of a plurality of systems, for example, even if one of the transmission paths is disconnected, the remaining transmission path is used, to enable the system itself to be continuously operated.

Incidentally, the seventh embodiment has explained the case where the integrated-signal processing device 150 includes a plurality of connection interfaces and configures transmission paths of a plurality of systems with the connection interfaces. However, in each of the transmission paths, a device housing such as an integrated antenna device may be additionally installed using the connection in the daisy chain mode.

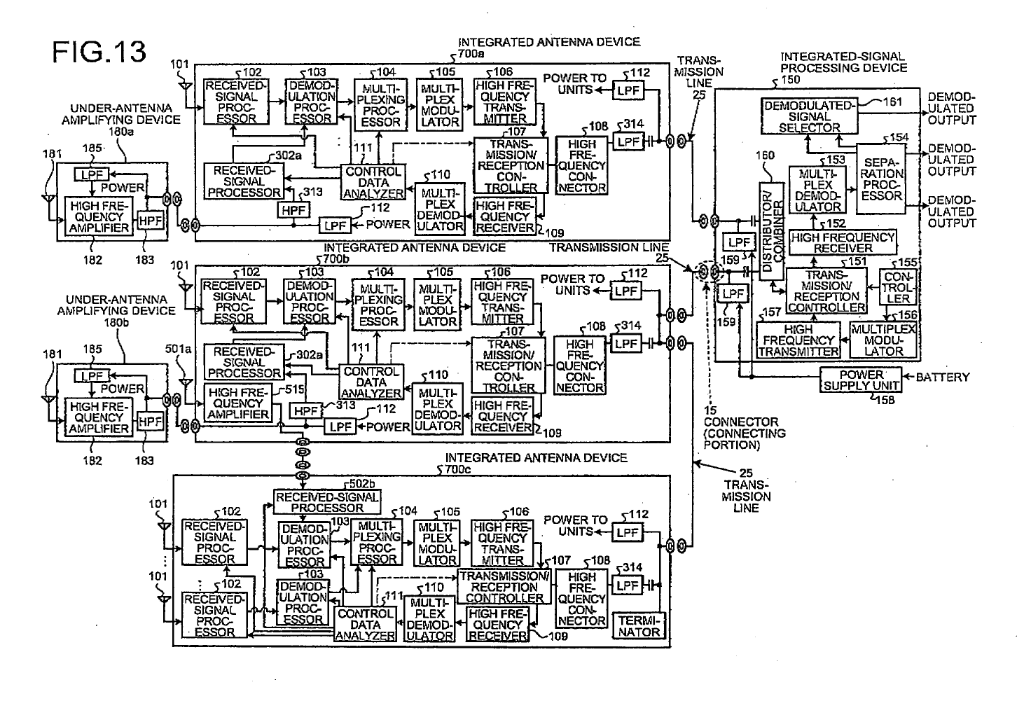

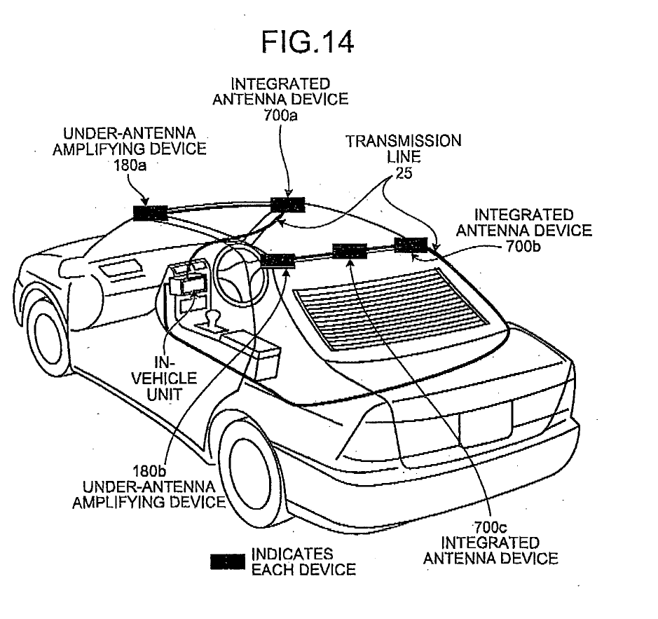

Therefore, in an eighth embodiment as follows, a case where an integrated antenna device is connected in the daisy chain mode to one of the transmission paths of the plurality of systems beginning at the integrated-signal processing device 150 will be explained below with reference to FIG. 13 and FIG. 14. FIG. 13 is a diagram of a configuration example of an integrated reception system according to the eighth embodiment, and FIG. 14 is a schematic illustrating an example of how the integrated reception system according to the eighth embodiment is installed in the vehicle. In FIG. 13, the same numerals are assigned to the same components as these in the integrated reception systems according to the embodiments.

As shown in FIG. 13, the integrated reception system according to the eighth embodiment includes the integrated-signal processing device 150 with two connection interfaces, integrated antenna devices 700a to 700c, the under-antenna amplifying devices 180a and 180b, the connectors 15, and the transmission lines 25.

Similarly to the seventh embodiment, the integrated antenna device 700a and the under-antenna amplifying device 180a are connected to each other to be formed as a front-side antenna device. Likewise, the integrated antenna device 700b and the under-antenna amplifying device 180b are formed as a rear-side antenna device.

Moreover, the integrated antenna device 700c can be added in the daisy chain mode to the configuration of the rear-side antenna device. More specifically, the integrated antenna device 700b and the integrated antenna device 700c are connected to each other by the transmission line 25 and the connectors 15.

In addition, similarly to the seventh embodiment, the integrated-signal processing device 150 and the integrated antenna device 700a are connected to each other through one of the connection interfaces of the integrated-signal processing device 150, and the integrated-signal processing device 150 and the integrated antenna device 700b are connected to each other through the other connection interface, these connections being implemented by the transmission line 25 and the connectors 15.

Here, an arrangement of the devices when the physical connection is implemented will be explained with reference to FIG. 14. It should be noted that the arrangement of the transmission lines is the same as the example shown in the seventh embodiment (see FIG. 11).

As shown in FIG. 14, the devices of the integrated reception system according to the eighth embodiment can be arranged in such a manner that, for example, the integrated antenna device 700a and the under-antenna amplifying device 180a can be arranged as the front-side antenna device in the front portion of the vehicle.

Likewise, the integrated antenna device 700b, the integrated antenna device 700c, and the under-antenna amplifying device 180b can be arranged as the rear-side antenna device in the rear portion of the vehicle. By arranging the devices separately, the diversity structure is allowed.

It should be noted that the processors of the integrated-signal processing device 150 as shown in FIG. 13 are the same as these of the seventh embodiment, and thus explanation thereof is omitted here. Furthermore, the integrated antenna devices 700a to 700c and the under-antenna amplifying devices 180a and 180b are the same as these of the fifth embodiment, and thus, explanation thereof is omitted here.

As explained above, the integrated reception system according to the eighth embodiment is configured to connect, in the daisy chain mode, the device housing such as the integrated antenna device to each of the transmission paths of the plurality of systems each beginning at the integrated-signal processing device 150. Therefore, for example, if it is desired to improve reception sensitivity of an antenna, a device housing can be additionally installed without large modification of the arrangement of the transmission lines 25.

In addition, because the transmission paths are configured as a plurality of systems, for example, when a device housing is to be additionally installed on the rear-side transmission path, the addition can affect only the devices arranged on the same transmission path.

Incidentally, the seventh and the eighth embodiments have explained the case where the integrated reception system according to the present invention has the diversity structure using the antenna selection method. However, particular media (e.g., digital TV) may be formed as the diversity structure using a maximal-ratio combining.

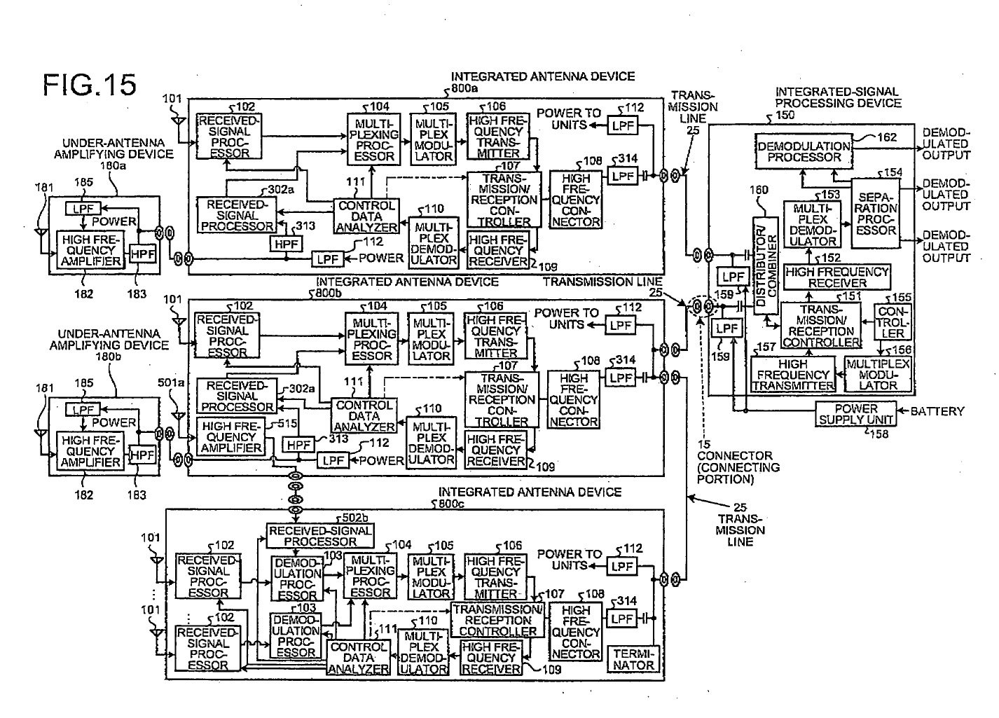

Therefore, in a ninth embodiment as follows, a case where the integrated reception system according to the present invention has the diversity structure using the maximal-ratio combining for the particular media will be explained below with reference to FIG. 15. FIG. 15 is a diagram of a configuration example of an integrated reception system according to the ninth embodiment.

As shown in FIG. 15, the integrated reception system according to the ninth embodiment includes the integrated-signal processing device 150 with two connection interfaces, integrated antenna devices 800a to 800c, the under-antenna amplifying device 180a, the under-antenna amplifying device 180b, the connectors 15, and the transmission lines 25.

The physical connection of the devices, the arrangement of the transmission lines 25, and the arrangement of the devices installed in the vehicle are the same as these of the eighth embodiment, and thus explanation thereof is omitted here.

As shown in FIG. 15, the integrated-signal processing device 150 includes the transmission/reception controller 151, the high frequency receiver 152, the multiplex demodulator 153, the separation processor 154, the controller 155, the multiplex modulator 156, the high frequency transmitter 157, the power supply unit 158, the two LPFs 159 corresponding to the two connection interfaces, the distributor/combiner 160, and a demodulation processor 162.

Here, the demodulation processor 162 is a processor that combines signals separated for each signal system by the separation processor 154 using the maximal-ratio combining for the particular media, demodulates and outputs the signals. This allows improvement of the reception sensitivity by combining the high frequency signals of digital TV received by a plurality of antennas.

As for the signal system of the particular media through which the signals are combined/demodulated and output by the demodulation processor 162, the demodulation process in each of the integrated antenna devices as shown in the embodiments may not be performed. Therefore, for example, the signal received by the antenna 101 of the integrated antenna device 800a shown therein is not subjected to the demodulation process in the integrated antenna device 800a, but is combined/demodulated and output by the integrated-signal processing device 150.

The process related to the signal system of other media using the antenna selection method, the other processors in the integrated-signal processing device 150 and the integrated antenna devices 800a to 800c, the under-antenna amplifying device 180a, and the under-antenna amplifying device 180b are the same as these of the eighth embodiment, and thus explanation thereof is omitted here.

As explained above, the integrated reception system according to the ninth embodiment is configured to form transmission paths of a plurality of systems and use the maximal-ratio combining for the particular media. Therefore, if the reception sensitivity of the particular media is desired to be improved, it is possible to achieve the diversity structure in which not only the antenna selection method but also the maximal-ratio combining is used while the transmission lines 25 are arranged with a high degree of freedom.

As is clear from the above, the integrated reception system disclosed in the present application is useful for the case in which the integrated reception system for receiving signals of a plurality of systems is installed in the vehicle, and is particularly suitable for achievement of space saving and cost saving.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An integrated reception system comprising:
an integrated antenna device that includes
a demodulation processor that demodulates a digital signal in a subsequent stage of a received-signal processor for converting a high frequency signal received by an antenna into the digital signal and in a previous stage of a multiplexing processor for multiplexing digital signals;
a first digital modulation processor that modulates the high frequency signal based on a modulated signal multiplexed by the multiplexing processor; and
a first communication processor that outputs the high frequency signal modulated by the first digital modulation processor, the integrated antenna device being disposed near the antenna;
an integrated-signal processing device that includes
a multiplex demodulator that demodulates the high frequency signal output from the integrated antenna device; and
a power feed unit that feeds power to the integrated antenna device; and
a transmission line, being a plurality of coaxial cables, that connects between the integrated antenna device and the integrated-signal processing device, and at both ends of which a connector is provided.

2. The integrated reception system according to claim 1, wherein
the antenna is disposed in plural locations and receives a plurality of signals of different signal systems,
the integrated antenna device is disposed in at least one location near the antennas disposed in the plural locations,
the received-signal processor is disposed in the same number as the antennas disposed in the plural locations, and converts a high frequency signal received by each of the antennas disposed in the plural locations into a digital signal,
the demodulation processor demodulates the digital signal converted by the received-signal processor disposed in the plural locations,
the first communication processor attenuates the high frequency signal modulated by the multiplex modulator by a predetermined amount of attenuation, and outputs attenuated high frequency signal, and
the integrated-signal processing device further includes
a separation processor that separates the demodulated signal demodulated by the multiplex demodulator into demodulated signals each digitized for each of the signal systems,
a controller that generates a control signal for the integrated antenna device,
a second digital modulation processor that modulates the high frequency signal based on the control signal generated by the controller, and
a second communication processor that outputs the high frequency signal modulated by the second digital modulation processor to the transmission line.

3. The integrated reception system according to claim 1, wherein
the antenna is disposed in plural locations and receives a plurality of signals of different signal systems,
the integrated antenna device is disposed in one location near the antennas disposed in the plural locations,
the received-signal processor is disposed in the same number as the antennas disposed in the plural locations, and converts a high frequency signal received by each of the antennas disposed in the plural locations into a digital signal,
the demodulation processor demodulates the digital signal converted by the received-signal processor disposed in the plural locations, and
the integrated-signal processing device further includes
a separation processor that separates the demodulated signal demodulated by the multiplex demodulator into demodulated signals each digitized for each of the signal systems,
a controller that generates a control signal for the integrated antenna device,
a second digital modulation processor that modulates the high frequency signal based on the control signal generated by the controller, and
a second communication processor that outputs the high frequency signal modulated by the second digital modulation processor to the transmission line.

4. The integrated reception system according to claim 1, wherein
the antenna is disposed in plural locations and receives a plurality of signals of different signal systems, wherein the integrated reception system further comprises
an under-antenna amplifying device that is disposed near an antenna arranged between the integrated antenna device and the integrated-signal processing device which are connected to each other through the transmission line, and that includes a high frequency amplifier for amplifying a high frequency signal received by the antenna, wherein
the integrated antenna device is disposed in one location near the antennas disposed in the plural locations,
the received-signal processor is disposed in locations more than the antennas disposed in the plural locations, and converts a high frequency signal received by each of the antennas disposed in the plural locations or a high frequency signal amplified by the under-antenna amplifying device into a digital signal,
the demodulation processor demodulates the digital signal converted by the received-signal processor disposed in the plural locations,
the integrated-signal processing device further includes
a separation processor that separates the demodulated signal demodulated by the multiplex demodulator into demodulated signals each digitized for each of the signal systems,
a controller that generates a control signal for the integrated antenna device,
a second digital modulation processor that modulates the high frequency signal based on the control signal generated by the controller, and
a second communication processor that outputs the high frequency signal modulated by the second digital modulation processor to the transmission line, and
the power feed unit further feeds power to the under-antenna amplifying device, and
a signal frequency of the high frequency signal modulated by the first digital modulation processor and the second digital modulation processor is different from a signal frequency of the high frequency signal amplified by the high frequency amplifier.

5. The integrated reception system according to claim 1, wherein
the antenna is disposed in plural locations and receives a plurality of signals of different signal systems, wherein the integrated reception system further comprises
an under-antenna amplifying device that is disposed near an antenna arranged between the integrated antenna device and the integrated-signal processing device which are connected to each other through the transmission line, and that includes a first high frequency amplifier for amplifying a high frequency signal received by the antenna, wherein
the integrated antenna device is disposed in at least two locations near the antennas disposed in the plural locations,
in at least one of the integrated antenna devices, the received-signal processor is disposed in locations more than the antennas disposed in the plural locations, and converts a high frequency signal received by each of the antennas disposed in the plural locations or a high frequency signal amplified by the first high frequency amplifier into a digital signal,
the demodulation processor demodulates the digital signal converted by the received-signal processor disposed in the plural locations,
the first communication processor attenuates the high frequency signal modulated by the multiplex modulator by a predetermined amount of attenuation and outputs attenuated high frequency signal,
the integrated-signal processing device further includes
a separation processor that separates the demodulated signal demodulated by the multiplex demodulator into demodulated signals each digitized for each of the signal systems,
a controller that generates a control signal for the integrated antenna device,
a second digital modulation processor that modulates the high frequency signal based on the control signal generated by the controller, and
a second communication processor that outputs the high frequency signal modulated by the second digital modulation processor to the transmission line, and
the power feed unit further feeds power to the under-antenna amplifying device, and
a signal frequency of the high frequency signal modulated by the first digital modulation processor and the second digital modulation processor is different from a signal frequency of the high frequency signal amplified by the first high frequency amplifier.

6. The integrated reception system according to claim 1, wherein
the antenna is disposed in plural locations and receives a plurality of signals of different signal systems, wherein the integrated reception system further comprises
an under-antenna amplifying device that is disposed near an antenna arranged between the integrated antenna device and the integrated-signal processing device which are connected to each other through the transmission line, and that includes a first high frequency amplifier for amplifying a high frequency signal received by the antenna, wherein
the integrated antenna device is disposed in at least two locations near the antennas disposed in the plural locations, and further includes a second high frequency amplifier for amplifying a high frequency signal received by one of the antennas disposed in the plural locations in each of the integrated antenna devices,
in at least one of the integrated antenna devices, the received-signal processor is disposed in locations more than the antennas disposed in the plural locations, and converts a high frequency signal received by each of the antennas disposed in the plural locations or a high frequency signal amplified by the under-antenna amplifying device into a digital signal,
in each of the integrated antenna devices, the received-signal processor converts the high frequency signal amplified by the second high frequency amplifier included in an integrated antenna device which is different from its own device into a digital signal,
the demodulation processor demodulates the digital signal converted by the received-signal processor disposed in the plural locations,
the first communication processor attenuates the high frequency signal modulated by the multiplex modulator by a predetermined amount of attenuation and outputs attenuated high frequency signal,
the integrated-signal processing device further includes
a separation processor that separates the demodulated signal demodulated by the multiplex demodulator into demodulated signals each digitized for each of the signal systems,
a controller that generates a control signal for the integrated antenna device,
a second digital modulation processor that modulates the high frequency signal based on the control signal generated by the controller, and
a second communication processor that outputs the high frequency signal modulated by the second digital modulation processor to the transmission line,
the power feed unit further feeds power to the under-antenna amplifying device,
the transmission line further connects between the second high frequency amplifier and the received-signal processor included in the integrated antenna device different from its own device, and
a signal frequency of the high frequency signal modulated by the first digital modulation processor and the second digital modulation processor is different from a signal frequency of the high frequency signal amplified by the first high frequency amplifier.

7. An integrated reception system comprising:
an integrated antenna device that includes
a received-signal processor that converts a high frequency signal received by an antenna into a digital signal;
a demodulation processor that demodulates the digital signal;
a multiplexing processor that multiplexes digital signals;
a first digital modulation processor that modulates the high frequency signal based on the digital signals multiplexed by the multiplexing processor; and
a first communication processor that outputs the high frequency signal modulated by the first digital modulation, processor, the integrated antenna device being disposed near the antenna;
an integrated-signal processing device that includes
a multiplex demodulator that demodulates the high frequency signal output from the integrated antenna device; and
a power feed unit that feeds power to the integrated antenna device; and
a plurality of transmission lines each of which connects between the integrated antenna device and the integrated-signal processing device, and each of the transmission lines being provided with a connector at both ends thereof.

8. The integrated reception system according to claim 7, wherein
the integrated-signal processing device includes a plurality of connection interfaces through each of which communication with a receiving device disposed near the antenna is performed, and
the receiving device is connected to each of the plurality of connection interfaces through the transmission line.

9. The integrated reception system according to claim 8, wherein
the receiving device includes the integrated antenna device and an under-antenna amplifying device that amplifies a signal received by the antenna, and
the integrated antenna device and the under-antenna amplifying device are separately arranged and are connected in series through the transmission line.

10. The integrated reception system according to claim 7, wherein the integrated-signal processing device further includes
a distributor that, when a sending signal is to be sent through the plurality of connection interfaces, distributes the sending signal according to the respective connection interfaces; and
a combiner that combines signals received through the plurality of connection interfaces.

11. The integrated reception system according to claim 7, wherein the integrated-signal processing device further includes a signal selection-output unit that selects an optimal signal among a plurality of signals of signal systems of the antenna and outputs selected optimal signal.

12. The integrated reception system according to claim 7, wherein the integrated-signal processing device further includes a maximal-ratio combination-output unit that combines a plurality of signals of signal systems of the antenna and outputs combined signals.

13. The integrated reception system according to claim 8, wherein the receiving device includes
an add-on connection interface through which communication with the receiving device for add-on is performed, and
the receiving device for add-on is connected in series to the add-on connection interface through the transmission line.
